(19) United States
(12) Patent Application Publication
(10) Pub. No.: US 2021/0174269 A1
(43) Pub. Date: Jun. 10, 2021

(54) METHOD AND SYSTEM FOR RESERVING FUTURE PURCHASES OF GOODS

(71) Applicant: LINE Plus Corporation, Seongnam-si (KR)

(72) Inventors: Seong Woon LEE, Seongnam-si (KR); Baek Bum PYUN, Seongnam-si (KR); Ik Hun UM, Seongnam-si (KR)

(73) Assignee: LINE Plus Corporation, Seongnam-si (KR)

(21) Appl. No.: 17/110,453

(22) Filed: Dec. 3, 2020

(30) Foreign Application Priority Data
Dec. 5, 2019 (KR) 10-2019-0160523

(51) Int. Cl. G06Q 10/02; G06Q 30/06; G06Q 20/08; G06Q 20/42; G06Q 30/02

(52) U.S. Cl. CPC G06Q 10/02; G06Q 30/0633; G06Q 30/0206; G06Q 20/42; G06Q 30/0201; G06Q 20/085

(57) ABSTRACT

The present disclosure relates to a method for reserving future purchases of goods, which includes receiving a purchase reservation request including user information, information on a product to be purchased, and a desired purchase condition from a user terminal, receiving a plurality of payment information on product to be purchased, monitoring whether at least one of the received plurality of payment information satisfies the desired purchase condition, and processing the purchase transaction of the product to be purchased using payment method information received from the user terminal, based on a result of the monitoring.

### CROSS-REFERENCE TO RELATED APPLICATION

This application claims priority under 35 U.S.C § 119 to Korean Patent Application No. 10-2019-0160523, filed in the Korean Intellectual Property Office on Dec. 5, 2019, the entire contents of which are hereby incorporated by reference.

### FIELD

The present disclosure relates to methods and/or systems for reserving future purchases of goods, and more specifically, to methods and/or systems for reserving future purchases of goods that are capable of providing a service for reserving future purchases of goods by automatically processing a purchase transaction of a product to be purchased, using a purchase reservation request received from a user terminal.

### BACKGROUND

The proliferation of mobile devices and the development of the Internet have led into increased scale of e-commerce, such that rapidly increasing number of sellers and buyers sell and purchase products through e-commerce. Numerous different sellers sell the same product on the Internet, often setting different prices for the same product or adjusting the price in order to increase sales quantity. Accordingly, consumers need to continuously invest time to search and monitor numerous seller sites on the Internet and so on, in order to purchase a product they want at a desired price.

In addition, since the price for purchasing the same product may vary according to the consumers' abilities to use the Internet, there is a problem in that it is difficult for a consumer with low Internet utilization ability to purchase a desired product at a desired price range. To solve this problem, a service is available, which finds the stores that offer the cheapest price for various products, but despite the lowest price, it is sometimes not easy to find the store where the buyers can purchase the product immediately, when considering false offerings registered by sellers, for example.

Meanwhile, due to the nature of e-commerce transactions in which the sellers do not directly meet the consumers, it is difficult for the sellers to predict consumer demand. For this reason, sellers cannot respond quickly to changes in consumer demand. In addition, this also causes a problem that it is difficult for the sellers to efficiently manage inventory of products.

### SUMMARY

The present disclosure provides methods, a non-transitory computer-readable storage media storing instructions, and systems for reserving future purchases of goods, which solve the problems described above.

Methods and systems for reserving future purchases of goods, which receive a purchase reservation request and a plurality of payment information on a product to be purchased, monitor whether at least one of the received plurality of payment information satisfies a desired purchase condition included in the purchase reservation request, and process a purchase transaction of the product to be purchased, are provided.

Methods and systems for predicting consumer demand, which are capable of generating statistical information based on a plurality of purchase reservation requests and providing the generated statistical information to a seller account, are also provided.

The present disclosure may be implemented in various ways, including methods, systems, or non-transitory computer-readable storage media storing instructions.

According to an example embodiment, a method for reserving future purchases of goods performed by one or more processors includes receiving a purchase reservation request from a user terminal, the purchase reservation request including user information, information on a product to be purchased, and a desired purchase condition, receiving a plurality of payment information on the product to be purchased, monitoring whether at least one of the received plurality of payment information satisfies the desired purchase condition, and processing the purchase transaction of the product to be purchased using payment method information received from the user terminal, based on a result of the monitoring.

The purchase reservation request may further include the payment method information, and the processing may include automatically performing, without a user input, the purchase transaction of the product to be purchased using store information included in specific payment information that satisfies the desired purchase condition among the received plurality of payment information, and using the user information and the payment method information included in the purchase reservation request, and transmitting information related to the purchase transaction to the user terminal.

The processing may include transmitting at least one of store information or information on payment amount included in specific payment information, from among the received plurality of payment information, that satisfies the desired purchase condition to the user terminal, receiving a purchase approval for the product to be purchased from the user terminal, and performing the purchase transaction of the product to be purchased using the store information, the user information, and the payment method information.

The receiving the purchase reservation request may include converting at least one of the received information on the product to be purchased or the desired purchase condition into a standardized notation.

Each of the plurality of payment information may include at least one of product information, store information, or information on payment amount, and the receiving the plurality of payment information on the product to be purchased may include converting at least one of the product information, the store information, or the information on payment amount included in each of the received plurality of payment information into a standardized notation.

According to an example embodiment, the processing may include processing the purchase transaction of the product to be purchased using the information on a store, the user information, and the payment method information, in response to the result of the monitoring indicating that a desired quantity of the product to be purchased has been purchased at the store satisfying the desired purchase condition.

The processing may include processing the purchase transaction of the product to be purchased using the information on a specific store, the user information, and the payment method information, in response to the result of the monitoring indicating that purchases satisfying the desired purchase condition have been made for a desired period of time at the specific store.

The processing may include assigning priority based on reception time of the purchase reservation request and another purchase reservation request, in response to receiving the another purchase reservation request that competes with the purchase reservation request, and processing the purchase transaction for each of the purchase reservation request and the another purchase reservation request based on the assigned priority.

The processing may include assigning priority based on grades of users who have generated the purchase reservation request and another purchase reservation request, in response to receiving the another purchase reservation request that competes with the purchase reservation request, and processing the purchase transaction for each of the purchase reservation request and the another purchase reservation request based on the assigned priority.

The information on the product to be purchased may include at least one of a product name, a product model name, a product image, or a detailed option.

The monitoring may include determining a specific payment information, from among the plurality of payment information, which is more advantageous than the desired purchase condition as the payment information that satisfies the desired purchase condition.

The processing may include determining whether the product to be purchased that satisfies the desired purchase condition can be purchased under the desired purchase condition using store information and the payment method information received from the user terminal, and transmitting a message requesting an input of another payment method information to the user terminal in response to a result of the determining indicating that the another payment method information different from the payment method information received from the user terminal is desired to purchase the product to be purchased under the desired purchase condition.

The method may further include receiving a plurality of purchase reservation requests from a plurality of terminals, each of the plurality of purchase reservation requests including respective user information, respective information on each product to be purchased, and a respective desired purchase condition, generating statistical information based on the plurality of purchase reservation requests, and transmitting the generated statistical information to a seller terminal associated with a seller account.

The receiving the plurality of purchase reservation requests may include converting at least one of the respective information on each product to be purchased or the respective desired purchase condition included in each of the received plurality of purchase reservation requests into a standardized notation.

The generating the statistical information based on the plurality of purchase reservation requests may include generating statistics on the respective desired purchase condition for each product to be purchased included in each of the received plurality of purchase reservation requests, and the transmitting the generated statistical information to the seller terminal associated with the seller account may include identifying a specific product sold by the seller account, and providing a subset of the statistics on the desired purchase condition for the specific product sold by the seller account to the seller terminal associated with the seller account.

The method may further include receiving a modified selling price for a specific product for sale from the seller account, determining at least one purchase reservation request, from among the plurality of purchase reservation requests, that includes the respective desired purchase condition satisfied by the modified selling price, and processing the purchase transaction for the at least one purchase reservation request.

There is provided a non-transitory computer-readable recording medium storing instructions for execution by the one or more processors that, when executed by the one or more processors, cause the one or more processors to perform the method for reserving future purchases of goods described above.

According to an example embodiment, a system for reserving future purchases of goods according includes a memory, and at least one processor connected to the memory and configured to execute computer-readable commands stored in the memory. The at least one processor is configured to receive a purchase reservation request including user information, information on a product to be purchased, and a desired purchase condition, and store the purchase reservation request in the memory, receive a plurality of payment information on the product to be purchased and store the plurality of payment information in the memory, monitor whether at least one of the received plurality of payment information satisfies the desired purchase condition, and process a purchase transaction of the product to be purchased using received payment method information based on a monitoring result.

The effects of the present disclosure are not limited to the effects described above, and other effects that are not mentioned above can be clearly understood to those skilled in the art based on the description provided below.

### DESCRIPTION OF THE DRAWINGS

Embodiments of the present disclosure will be described with reference to the accompanying drawings described below, where similar reference numerals indicate similar components, but are not limited thereto, in which:

FIG. 1 is a schematic diagram showing a configuration in which an information processing system is communicatively connected with a plurality of user terminals in order to provide a goods purchase reservation service according to an example embodiment;

FIG. 2 is a block diagram showing an internal configuration of a user terminal and an information processing system according to an example embodiment;

FIG. 3 is a block diagram showing a configuration of an information processing system according to an example embodiment;

FIG. 4 is a block diagram showing an internal configuration of a user terminal and an information processing system according to an example embodiment;

FIG. 5 is a diagram showing an example in which a purchase reservation request is converted into a standardized notation and then stored according to an example embodiment;

FIG. 6 is a diagram showing an example purchase reservation request DB according to an example embodiment;

FIG. 7 is a diagram showing an example in which a payment request is converted into a standardized notation and then stored according to an example embodiment;

FIG. 8 is a diagram showing an example payment information DB according to an example embodiment;

FIG. 9 is a diagram showing an example of a screen for purchasing or reserving future purchase of a specific product according to an example embodiment;

FIG. 10 is a diagram showing an example of generating a purchase reservation request according to an example embodiment;

FIG. 11 is a diagram showing an example of querying, by a user, the generated purchase reservation request according to an example embodiment;

FIG. 12 is a diagram showing an example of providing information related to a purchase transaction to the user after a product to be purchased is automatically purchased, according to an example embodiment;

FIG. 13 is a flowchart showing a method for reserving future purchases of goods according to an example embodiment;

FIG. 14 is a diagram showing an example of displaying statistical information on a purchase reservation request on a screen of a user terminal, according to an example embodiment; and

FIG. 15 is a flowchart showing a method for predicting consumer demand according to an example embodiment.

### DETAILED DESCRIPTION

Hereinafter, specific details for the practice of the present disclosure will be described in detail with reference to the accompanying drawings. However, in the following description, detailed descriptions of well-known functions or configurations will be omitted when it may make the subject matter of the present disclosure rather unclear.

In the accompanying drawings, the same or corresponding components are given the same reference numerals. In addition, in the following description of the example embodiments, duplicate descriptions of the same or corresponding components may be omitted. However, even if descriptions of components are omitted, it is not intended that such components are not included in any example embodiment.

Advantages and features of the disclosed example embodiments and methods of accomplishing the same will be apparent by referring to embodiments described below in connection with the accompanying drawings. However, the present disclosure is not limited to the example embodiments disclosed below, and may be implemented in various different forms, and the present example embodiments are merely provided to make the present disclosure complete, and to fully disclose the scope of example embodiments to those skilled in the art to which the present disclosure pertains.

The terms used herein will be briefly described prior to describing the disclosed example embodiments in detail. The terms used herein have been selected as general terms, which are widely used at present in consideration of the functions of the present disclosure, and this may be altered according to the intent of an operator skilled in the art, conventional practice, or introduction of new technology. In addition, in a specific case, a term is arbitrarily selected by the applicant, and the meaning of the term will be described in detail in a corresponding description of the example embodiments. Therefore, the terms used in the present disclosure should be defined based on the meaning of the terms and the overall contents of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it intends to mean that the portion may additionally comprise (or include or have) another component, rather than excluding the same, unless specified to the contrary.

Further, the term “module” or “unit” used herein refers to hardware component, or a combination of hardware and software components, and “module” or “unit” performs certain roles. However, the meaning of the “module” or “unit’ is not limited to software or hardware. The “module’ or ‘unit” may be configured to be in an addressable storage medium or configured to execute one or more processors. Accordingly, as an example, the “module” or “unit” may include components such as software components, object-oriented software components, class components, and task components, and at least one of processes, functions, attributes, procedures, subroutines, program code segments of program code, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units”.

According to an example embodiment of the present disclosure, the “module” or “unit” may be implemented as a processor and a memory. The term “processor” should be interpreted broadly to encompass a general-purpose processor, a central processing unit (CPU), a microprocessor, a digital signal processor (DSP), a controller, a microcontroller, a state machine, and so forth. Under some circumstances, a “processor” may refer to an application-specific integrated circuit (ASIC), a programmable logic device (PLD), a field-programmable gate array (FPGA), and the like. The term “processor” may refer to a combination of processing devices, e.g., a combination of a DSP and a microprocessor, a plurality of microprocessors, one or more microprocessors in conjunction with a DSP core, or any other combination of such configurations. In addition, the term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and the like. The memory is said to be in electronic communication with a processor if the processor can read information from and/or write information to the memory. The memory that is integral to a processor is in electronic communication with the processor.

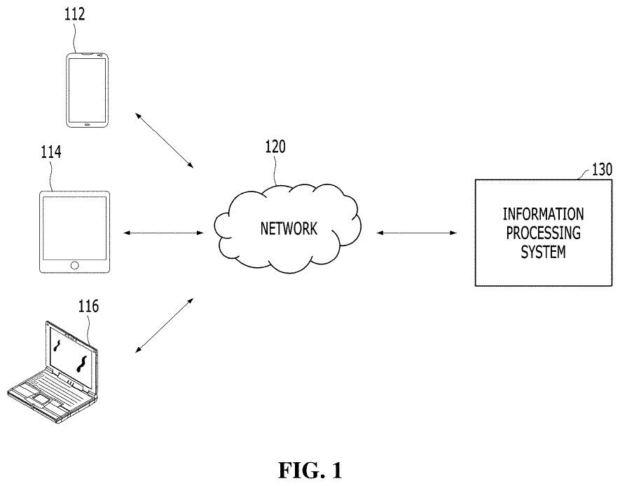

FIG. 1 is a schematic diagram showing a configuration in which an information processing system 130 is communicatively connected with a plurality of user terminals 112, 114, and 116 in order to provide a goods purchase reservation service according to an example embodiment. The information processing system 130 may provide a purchase reservation service to a plurality of user terminals 112, 114, and 116 through a network 120, and may also include a system (e.g., LINE Pay) that provides a payment service. According to an example embodiment, the information processing system 130 may include one or more server devices and/or databases, or one or more distributed computing devices and/or distributed databases based on cloud computing services that can store, provide and execute computer-executable programs (e.g., downloadable applications) and data related to goods purchase reservation services. The goods purchase reservation service provided by the information processing system 130 may be provided to a user through a dedicated application or a web browser application or the like installed on the plurality of user terminals 112, 114, and 116.

The plurality of user terminals 112, 114, and 116 may be in communication with the information processing system 130 through the network 120. The network 120 may be configured to enable communication between the plurality of user terminals 112, 114, and 116 and the information processing system 130. The network 120 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, or a combination thereof, depending on the installation environment.

In FIG. 1, a mobile phone terminal 112, a tablet terminal 114, and a PC terminal 116 are illustrated as examples of the user terminals, but example embodiments are not limited thereto, and the user terminal may be any computing device capable of wired and/or wireless communication and having a user interface capable of receiving information on a purchase reservation request from a user. For example, the user terminal may include a smart phone, a mobile phone, a navigation system, a computer, a notebook computer, a digital broadcasting terminal, a personal digital assistant (PDA), a portable multimedia player (PMP), a tablet PC, a game console, a wearable device, an internet of things (IoT) device, a virtual reality (VR) device, an augmented reality (AR) device, and the like. In addition, although FIG. 1 shows that three user terminals 112, 114, and 116 communicate with the information processing system 130 through the network 120, the embodiments are not limited thereto, and a different number of user terminals may be configured to communicate with the information processing system 130 through the network 120.

The method of communication is not limited, and may include a communication method using a communication network (e.g., mobile communication network, wired Internet, wireless Internet, broadcasting network, satellite network, and the like) that may be included in the network 120 as well as short-range wireless communication between user terminals. For example, the network 120 may include any one or more of networks including a personal area network (PAN), a local area network (LAN), a campus area network (CAN), a metropolitan area network (MAN), a wide area network (WAN), a broadband network (BBN), the Internet, and the like. In addition, the network 120 may include any one or more of network topologies including a bus network, a star network, a ring network, a mesh network, a star-bus network, a tree or hierarchical network, and the like, but not limited thereto.

The information processing system 130 may receive purchase reservation requests from a plurality of user terminals 112, 114, and 116 through the network 120. The received purchase reservation request may be stored in the memory of the information processing system 130 as purchase reservation information. The purchase reservation request may include information on a user who generated the purchase reservation request, information on product to be purchased that the user intends to purchase (e.g., product name, product model name, product image, detailed options, and the like), quantity to be purchased, purchase conditions with which the buyer desires to purchase the product (e.g., desired price, desired discount rate, desired payback, desired reward points, lowest price ever, and the like), payment method information (e.g., credit card information, debit card information, phone bill information, financial account, simple payment, and the like), and may be generated when the user wants an automatic purchase of a specific product in the future when a specific condition is satisfied. For example, when user A intends to purchase product A, which is currently sold for 500,000 won, for a lower price of 450,000 won, the user may generate a purchase reservation request so that a purchase transaction is automatically processed at a future point in time when any store selling product A for less than 450,000 won is checked. The product to be purchased is not limited to actual product, and includes all services, coupons, tickets, and the like that may be purchased online.

The information processing system 130 may receive a payment request from a plurality of user terminals 112, 114, and 116 through the network 120. The payment request may include information on the user who has generated the request, information on paid product, quantity, information on paid stores (e.g., online seller sites), settlement price, payment method information, and the like, and may be generated when a user wants to purchase a specific product immediately at a current selling price from a specific store. For example, when user A intends to purchase product A, which is currently sold at store A for 500,000 won, for 500,000 won, the user may generate a payment request so that the purchase transaction is processed immediately. In this case, the information processing system 130 may process the payment according to the received payment request and store the result of the processing in a memory as the payment information.

In an example embodiment, the information processing system 130 may be configured to monitor whether there is payment information, among the stored payment information, that satisfies the product to be purchased and the desired purchase condition of the previously received purchase reservation request. In this case, based on the monitoring result, the information processing system 130 may use the received payment method information to process a purchase transaction of the product to be purchased that satisfies the desired purchase condition. For example, when the purchase reservation request (to purchase product A for 450,000 won or less) generated by user A is satisfied with the payment information (that user B purchased product A for 440,000 won at store B), the information processing system 130 may use the payment information to automatically perform a transaction for the user A to purchase the product A at store B for 440,000 won without requiring a user input, or upon receiving confirmation from the user. The payment information used for the purchase transaction may be input when the user generates the purchase reservation request, or may be input when the user confirms whether or not to continue with the transaction.

As described above, by actively utilizing the payment information of other users to process the purchase reservation request, the user may easily make a purchase without having to continuously invest time to purchase the product he or she wants at a desired price. That is, the user is enabled to find the lowest price product that can actually be traded, not a false sale, using the payment information of the other users. In addition, while it is difficult for the sellers to predict the demand of the buyers and thus have to put efforts to manage the inventory, since the statistical information on the purchase reservation requests registered by the users are provided to sellers, the sellers are enabled to easily check the demand and demand price of product and also use them strategically.

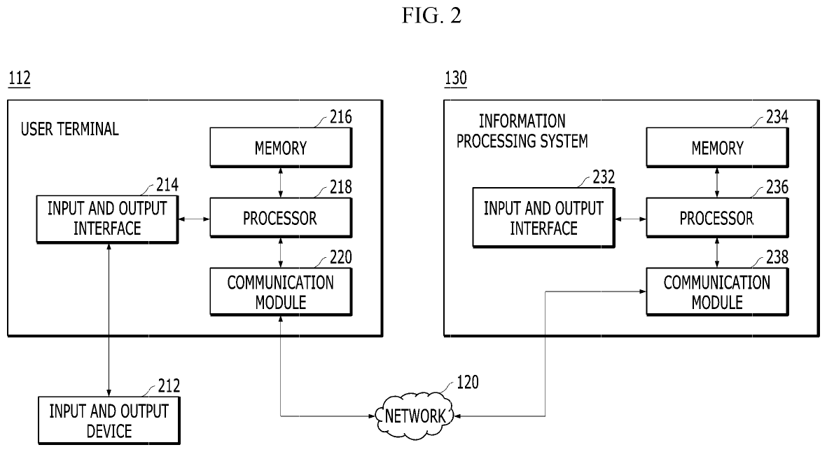

FIG. 2 is a block diagram showing an internal configuration of the user terminal 112 and the information processing system 130 according to an example embodiment. The user terminal 112 may include a memory 216, a processor 218, a communication module 220, and an input and output interface 214. Likewise, the information processing system 130 may include a memory 234, a processor 236, a communication module 238, and an input and output interface 232. As shown in FIG. 2, the user terminal 112 and the information processing system 130 may be configured to communicate information and/or data through the network 120 using the respective communication modules 220 and 238. In addition, the input and output device 212 may be configured to input information and/or data to the user terminal 112 or to output information and/or data generated from the user terminal 112 through the input and output interface 214. In FIG. 2, while the memory 216, the processor 218, the communication module 220, and the input and output interface 214 are shown as the internal configuration of the user terminal 112, other user terminals (e.g., the user terminals 114 and 116 of FIG. 1) may also include the internal configuration identical or similar to the internal configuration of the user terminal 112.

The memories 216 and 234 may include any non-transitory computer-readable recording medium. According to an example embodiment, the memories 216 and 234 may include a permanent mass storage device such as random access memory (RAM), read only memory (ROM), disk drive, solid state drive (SSD), flash memory, and the like. As another example, the permanent mass storage device such as ROM, SSD, flash memory, disk drive, and the like is a separate permanent storage device that is distinguished from the memories 216 and 234 and may be included in the user terminal 112 or the information processing system 130. In addition, the memories 216 and 234 may store an operating system and/or at least one program code (e.g., a code for a browser installed and driven in the user terminal 112 or an application dedicated to a purchase reservation service installed on the user terminal 112 to provide a purchase reservation service).

These software components may be loaded from a computer-readable recording medium separate from the memories 216 and 234. Such a separate computer-readable recording medium may include a recording medium directly connectable to the user terminal 112 and/or the information processing system 130, and may include a computer-readable recording medium such as a floppy drive, a disk, a tape, a DVD/CD-ROM drive, a memory card, and the like, for example. As another example, the software components may be loaded into the memories 216 and 234 through the communication modules 220 and 238 rather than the computer-readable recording medium. For example, at least one program may be loaded into the memories 216 and 234 based on a computer program (for example, an application dedicated to the purchase reservation service described above) installed by files provided by developers or a file distribution system that distributes an installation file of an application through the network 120.

The processors 218 and 236 may be configured to process a command of a computer program by performing basic arithmetic, logic, and input and output operations. The command may be provided to the processors 218 and 236 from the memories 216 and 234 or the communication modules 220 and 238. For example, the processors 218 and 236 may be configured to execute the received command according to program code stored in a recording device such as memories 216 and 234.

The communication modules 220 and 238 may provide a configuration or function for the user terminal 112 and the information processing system 130 to communicate with each other through the network 120, and may provide a configuration or function for the user terminal 112 and/or the information processing system 130 to communicate with another user terminal or other system (e.g., a separate cloud system, an open market, a shopping mall system, and the like). For example, a request (e.g., a purchase reservation request) generated by the processor 218 of the user terminal 112 according to the program code stored in the recording device such as the memory 216 may be transmitted to the information processing system 130 through the network 120 under the control of the communication module 220. Conversely, control signals or commands provided under the control of the processor 236 of the information processing system 130 may be received by the user terminal 112 through the communication module 220 of the user terminal 112 via the communication module 238 and the network 120. For example, the user terminal 112 may receive information related to the purchase reservation request from the information processing system 130 through the communication module 220.

The input and output interface 214 may be a means for interfacing with the input and output device 212. As an example, the input device may include a device such as a camera, a keyboard, a microphone, and a mouse, and the output device may include a device such as a display, a speaker, a haptic feedback device, and the like. As another example, the input and output interface 214 may be a means for interfacing with a device such as a touch screen or the like that provides an integrated configuration or an integrated function for performing inputting and outputting. For example, when the processor 218 of the user terminal 112 processes command of the computer program loaded in the memory 216, a service screen or content configured using the information and/or data provided by the information processing system 130 or other user terminals may be displayed on the display through the input and output interface 214. The input and output device 212 may be configured as one device with the user terminal 112. In addition, the input and output interface 232 of the information processing system 130 may be a means for interface with a device (not shown) for inputting or outputting that may be connected to, or included in the information processing system 130. In FIG. 2, the input and output interfaces 214 and 232 are illustrated as the components configured separately from the processors 218 and 236, but are not limited thereto, and the input and output interfaces 214 and 232 may be configured to be included in the processors 218 and 236.

The user terminal 112 and the information processing system 130 may include more than those components shown in FIG. 2. Meanwhile, it would be unnecessary to exactly illustrate most of the related components. According to an example embodiment, the user terminal 112 may be implemented to include at least some of the input and output devices described above. In addition, the user terminal 112 may further include other components such as a transceiver, a global positioning system (GPS) module, a camera, various sensors, a database, and the like. For example, when the user terminal 112 is a smartphone, it may generally include components included in the smartphone, and for example, it may be implemented such that various components such as an acceleration sensor or a gyro sensor, a camera module, various physical buttons, buttons using a touch panel, input/output ports, a vibrator for vibration, and the like are further included in the user terminal 112.

According to an example embodiment, the processor 218 of the user terminal 112 may be configured to operate an instant messaging application or a web browser application that provides a purchase reservation service. In this case, a program code associated with the application may be loaded into the memory 216 of the user terminal 112. While the application is running, the processor 218 of the user terminal 112 may receive information and/or data provided from the input and output device 212 through the input and output interface 214 or receive information and/or data from the information processing system 130 through the communication module 220, and process the received information and/or data and store it in the memory 216. In addition, such information and/or data may be provided to the information processing system 130 through the communication module 220.

According to an example embodiment, while the instant messaging application is running, the processor 218 may receive text, images, and the like, which may be inputted or selected through an input device such as a touch screen, a keyboard, or the like connected to the input and output interface, and store the received text and/or image in the memory 216 or provide it to the information processing system 130 through the communication module 220 and the network 120. For example, the processor 218 may receive information for generating a purchase reservation request or a transaction request through an input device such as a touch screen or a keyboard. Accordingly, the received text and/or image may be provided to the information processing system 130 through the communication module 220 and the network 120.

The processor 218 may be configured to output the processed information and/or data through an output device such as a device capable of outputting a display (e.g., touch screens, displays, and the like) of the user terminal 112 or a device capable of outputting an audio (e.g., a speaker). According to an example embodiment, information and/or data provided by an instant messaging application or web browser application that provides a purchase reservation service may be displayed through the device capable of outputting a display, or the like. According to another example embodiment, information and/or data provided by the instant messaging application or web browser application that provides a purchase reservation service may be output through the device capable of outputting an audio, or the like.

According to an example embodiment, the processor 236 of the information processing system 130 may be configured to manage, process, and/or store the information and/or data received from a plurality of user terminals including the user terminal 112 and/or a plurality of external systems. For example, the processor 236 may be configured to monitor the transaction information that satisfies a purchase reservation request received from a plurality of user terminals. As another example, the processor 236 may be configured to process statistical information on the received purchase reservation requests suitably for a specific seller. Hereinafter, a detailed description will be given of a specific method in which the processor 236 of the information processing system 130 processes a purchase transaction for a product to be purchased based on a purchase reservation request and provides a purchase reservation service to a user.

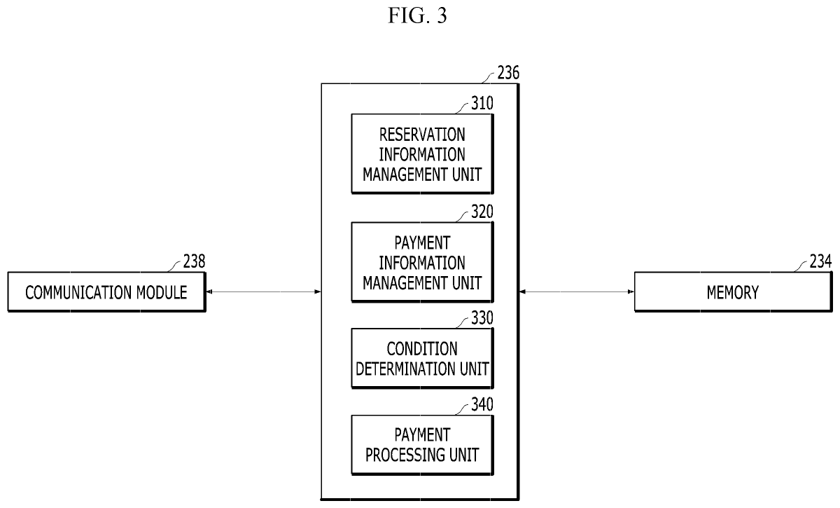

FIG. 3 is a block diagram showing a configuration of the information processing system 130 according to an example embodiment. The processor 236 of the information processing system 130 may be configured to include a reservation information management unit 310, a payment information management unit 320, a condition determination unit 330, and a payment processing unit 340. In addition, the processor 236 may transmit and receive information and/or data to and from an external system through the communication module 238. In addition, the processor 236 may store information and/or data in the memory 234 or obtain information and/or data from the memory 234.

The reservation information management unit 310 may be configured to receive a purchase reservation request from the communication module 238 and store the received purchase reservation request in the memory 234. The purchase reservation request may include information on product to be purchased, a desired purchase condition, and payment method information. In an example, the information on product to be purchased may include at least one of a product name, a product model name, a product image, or a detailed option, and the desired purchase condition may include at least one of desired purchase price information (e.g., a lowest price ever, a specific price, and the like) or benefit information (e.g., discount rate, payback, reward points, and the like). In this case, when the desired purchase condition is the information on the desired purchase price, it may be determined that the user desires a purchase at a price less than or equal to the price input by the user. In addition, when the desired purchase condition is associated with the benefit information provided to the user from the purchase, it may be determined that the user desires a purchase with a benefit input from the user or a greater benefit.

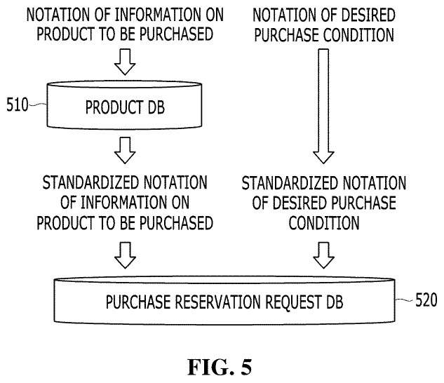

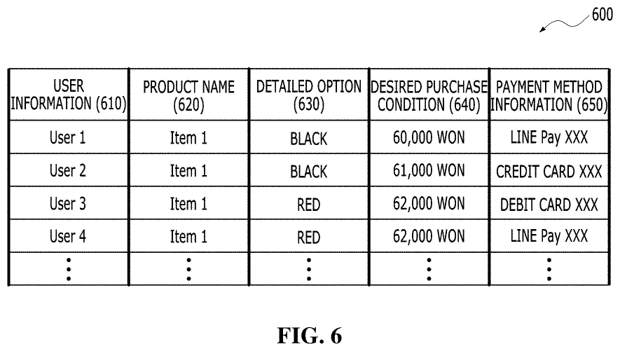

In an example embodiment, the reservation information management unit 310 may be configured to convert the information included in the received purchase reservation request into a standardized notation and then store it in the memory 234. For example, the reservation information management unit 310 may convert at least one of the information on product to be purchased or the desired purchase condition included in the purchase reservation request into a standardized notation. The purchase reservation request stored in the memory will be described in detail below with reference to FIGS. 5 and 6.

Meanwhile, the reservation information management unit 310 may delete the reservation information request stored in the memory 234. In an example embodiment, the reservation information management unit 310 may be configured such that, when a specific product is discontinued, the reservation information request for the corresponding product may be deleted. Further, the reservation information management unit 310 may be configured to delete the corresponding purchase reservation request when a desired (or alternatively, predetermined) period elapses from the time when the purchase reservation request is registered. For example, the reservation information management unit 310 may delete the purchase reservation request after 3 years from the registration. Additionally, the reservation information management unit 310 may be configured to delete the corresponding purchase reservation request when a desired (or alternatively, predetermined) period elapses after the desired purchase condition is satisfied. For example, when the desired purchase condition is satisfied but the user does not purchase the corresponding product for a certain period of time, the reservation information management unit 310 may delete the corresponding purchase reservation request. When deleting the purchase reservation request, the reservation information management unit 310 may provide information about this to the user terminal related to the user account that generated the deleted purchase reservation request through the communication module 238.

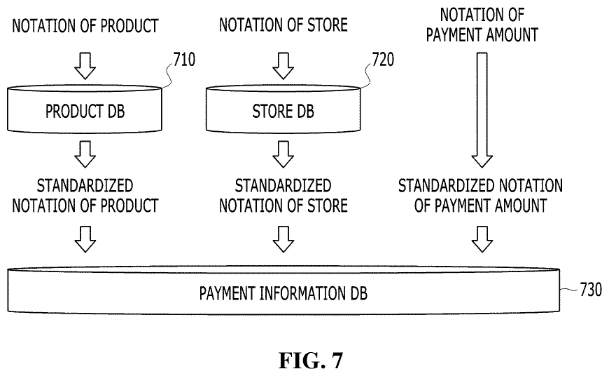

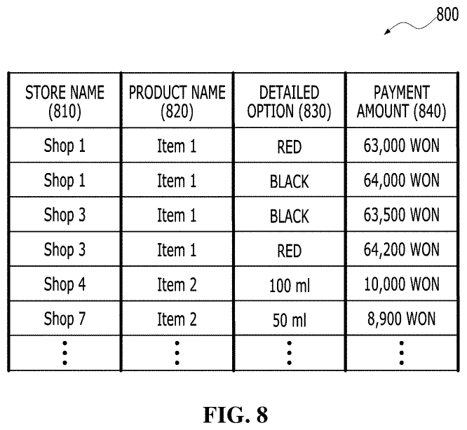

The payment information management unit 320 may be configured to receive payment information and store it in the memory 234. The payment information may include at least one of user information, product information, store information, or information on payment amount. In an example embodiment, the payment information management unit 320 may receive payment information from the payment processing unit 340 or an external system (e.g., open market system, shopping mall system, payment platform system, and the like). In an example embodiment, the payment information management unit 320 may be configured to convert the information included in the received payment information into a standardized notation and then store it in the memory 234. For example, the payment information management unit 320 may convert at least one of the product information, the store information, or the information on the payment amount included in the payment information into the standardized notation. The payment information stored in the memory will be described in detail below with reference to FIGS. 7 and 8.

The condition determination unit 330 may be configured to monitor whether or not a plurality of pieces of received payment information satisfies the product to be purchased and the desired purchase condition of the stored purchase reservation request. In an example embodiment, the condition determination unit 330 may compare the product information and the information on the payment amount included in the payment information with the product to be purchased and the desired purchase condition included in the stored purchase reservation request, and check whether or not there is the payment information that satisfies the desired purchase condition. At this time, when determining that a certain payment information, among the plurality of payment information, satisfies or is more advantageous than the desired purchase condition, the condition determination unit 330 may determine that payment information to be the payment information desired by the user for purchase. According to an example embodiment, when the desired purchase condition is the information on the price at which the user wants to purchase the product to be purchased, it may be determined that the user desires to purchase at a price less than or equal to the price input by the user. For example, when the product that the user intends to purchase is “Clova Friends” and “Brown”, and the price input from the user (that is, desired purchase condition) is 62,500 won, it may be determined that not only the payment information on the payment of 62,500 won, but also the payment information on the payment of 62,500 won or less satisfy the desired purchase condition for “Clova Friends” and “Brown”.

According to an example embodiment, when the desired purchase condition is associated with the benefit information provided to the user from the purchase, it may be determined that the user desires a purchase with a benefit input from the user or a greater benefit. For example, when the discount rate (that is, benefit information) input from the user is 10%, it may be determined that not only the payment information on the payment with 10% discount, but also the payment information on the payment with 10% discount or more are the payment information satisfying the desired purchase condition for “Clova Friends” and “Brown”.

When there is a purchase reservation request that satisfies the desired purchase condition, the condition determination unit 330 may provide the payment information corresponding to the purchase reservation request to the payment processing unit 340 and the purchase transaction for the purchase reservation request may be automatically processed without requiring a user input. Alternatively, the condition determination unit 330 may provide some or all of the information included in the payment information corresponding to the purchase reservation request to the user terminal related to the user account that generated the corresponding purchase reservation request through the communication module 238. In this case, the purchase transaction may be processed after confirmation from the user as to whether or not to proceed with the purchase transaction.

In an example embodiment, the condition determination unit 330 may be configured to determine that the condition is satisfied when it is determined that, based on a plurality of payment information, a desired (or alternatively, predetermined) quantity or more of the product to be purchased has been purchased at a specific store under the desired purchase condition. In some example embodiments, the payment processing unit 340 may be configured to determine that the condition is satisfied when it is determined that, for the product to be purchased, the purchases satisfying the desired purchase condition have been made for a desired (or alternatively, predetermined) period of time or longer at a specific store. With this configuration, it is possible to exclude the promotional events that are difficult to purchase in a normal way, such as special sales for promotional event, early bird sales, or the like.

The payment processing unit 340 may be configured to receive the purchase reservation request and the payment request and process the purchase transaction of the product. The purchase reservation request may be received from the condition determination unit 330, and the payment request may be received from the user terminal or the external system (e.g., open market system, shopping mall system, payment platform system, and the like). When processing the purchase and payment transactions of a product, the payment processing unit 340 may proceed with the payment and purchase using the received payment method information. In an example, the payment method information may include credit card information, debit card information, phone bill information, financial account information, simple payment information, and the like.

When receiving the payment information that satisfies the desired purchase condition and proceeding with the payment and purchase for the product to be purchased, the payment processing unit 340 may determine whether or not there is a condition for purchasing the product to be purchased with the corresponding payment amount. According to an example embodiment, when proceeding with the payment and purchase using the payment information received from the user terminal, the payment processing unit may determine whether or not the product to be purchased that satisfies the desired purchase condition may be purchased under the desired purchase condition by using payment method information received from the user terminal. In this case, when the payment processing unit 340 determines that a different type of payment method is desired to purchase the product to be purchased under the desired purchase condition, the payment processing unit 340 may transmit a message requesting to re-input the payment method (e.g., input another payment method) to the user terminal through the communication module 238. For example, when a specific payment method (e.g., LINE Pay) is desired to purchase the product to be purchased under the desired purchase condition, the payment processing unit 340 may transmit a message requesting the user to replace the payment method with the corresponding payment method. In this case, when the payment method information desired for purchase is received, the payment processing unit 340 may process the purchase transaction of the product to be purchased by using the changed payment method information.

When there is a plurality of purchase reservation requests that satisfy the desired purchase condition for the same product, the payment processing unit 340 may assign priority based on the time at which the requests are received and/or the grades of the users who generated the requests. In this case, the purchase reservation requests that compete with each other may be sequentially processed based on the assigned priority. In an example embodiment, when there are purchase reservation requests that competes with each other, the payment processing unit 340 may assign priority based on the time at which the requests are received. That is, the purchase reservation requests may be processed based on first in first out (FIFO) algorithm. In some example embodiments, when there are purchase reservation requests that competes with each other, the payment processing unit 340 may assign priority based on the grades of the users who generated the requests. For example, the payment processing unit 340 may give priority to purchase a reservation to a user of a higher user grade.

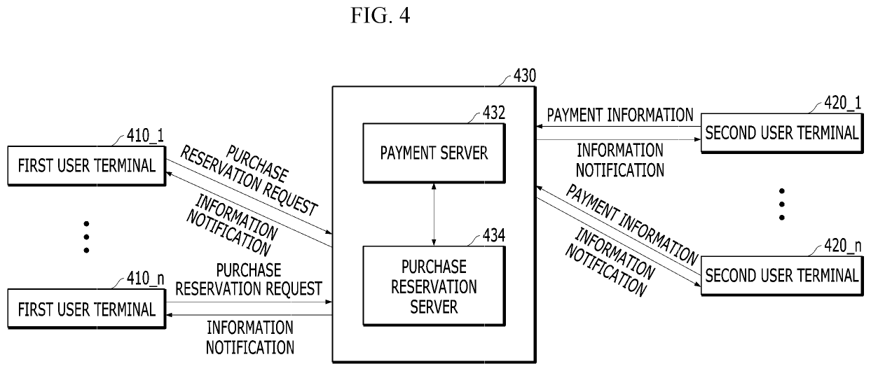

FIG. 4 is a block diagram showing an internal configuration of user terminals 410_1 to 410_n and 420_1 to 420_n and the information processing system 430 according to an example embodiment. As shown, the information processing system 430 may be configured to include a payment server 432 and a purchase reservation server 434. That is, in the information processing system 430, a server that provides a payment service and a server that provides a purchase reservation service may be configured as separate servers.

The purchase reservation server 434 may receive a plurality of purchase reservation requests each including the user information, the information on product to be purchased, the quantity to be purchased, the desired purchase condition, the payment method information, and the like from a plurality of first user terminals 410_1 to 410_n through a network. In some example embodiments, the quantity to be purchased, the payment method information, and the like may not be included in the purchase reservation request, and received from the first user terminals 410_1 to 410_n at a future point in time when the product is purchased as the desired purchase condition is satisfied. Additionally, the user may also modify the information included in the purchase reservation request at a future point in time when the desired purchase condition is satisfied. For example, it may be possible for the user to modify the information before proceeding with the product purchase process when the desired purchase condition is satisfied, or modify the information after proceeding with the purchase process.

In an example embodiment, the purchase reservation server 434 may convert the received plurality of purchase reservation requests into a standardized notation and store the same. For example, the purchase reservation server 434 may convert the information on product to be purchased, the desired purchase condition, and the like included in each of the purchase reservation requests into the standardized notation. The purchase reservation request converted into the standardized notation may be stored in the memory of the purchase reservation server 434. In some example embodiments, the purchase reservation request converted into the standardized notation may be stored in a storage device (e.g., cloud server device) separately provided outside the information processing system 430.

The payment server 432 may receive a plurality of payment requests each including the user information, information on paid product, quantity, information on paid stores, settlement price, payment method information, and the like from a plurality of second user terminals 420_1 to 420_n through a network. In this case, the information processing system 430 may process the payment according to the received payment request and store the result of the processing in a memory as the payment information. In FIG. 4, a plurality of first user terminals 410_1 to 410_n and a plurality of second user terminals 420_1 to 420_n are shown as separate groups, but are not limited thereto, and the user terminals may transmit the payment requests or the purchase reservation requests to the information processing system 430 according to the request of the user.

In an example embodiment, the payment server 432 may convert the generated payment information into a standardized notation and store the same. For example, the payment server 432 may convert the information on paid product, the information on paid store, the settlement price, and the like included in each payment information into the standardized notation. The payment information converted into the standardized notation may be stored in the memory of the payment server 432. In some example embodiments, the payment information converted into the standardized notation may be stored in a storage device (e.g., cloud server device) separately provided outside the information processing system 430.

The payment server 432 may provide the payment information to the purchase reservation server 434. In an example embodiment, the payment server 432 may provide all the stored payment information to the purchase reservation server 434 in real time. In another example embodiment, the payment server 432 may periodically or aperiodically provide the payment information to the purchase reservation server 434. In an example embodiment, the payment server 432 may provide only the payment information with a changed settlement price for the same product to the purchase reservation server 434. In another example embodiment, the payment server 432 may provide only the payment information for a product associated with the purchase reservation request stored in the purchase reservation server 434 to the purchase reservation server 434.

The purchase reservation server 434 may monitor whether or not there is a purchase reservation request, among the stored purchase reservation requests, that satisfies the desired purchase condition based on the payment information provided from the payment server 432. In an example, the desired purchase condition may be a lowest price ever, a discount rate, a payback, a reward point, a specific price to be purchased, and the like. The purchase reservation server 434 may provide a purchase reservation request that satisfies the desired purchase condition to the payment server 432 based on the result of the monitoring so that the payment server 432 may process the purchase transaction. In this case, the payment server 432 may store the payment information for the processed purchase transaction and provide the payment information to the purchase reservation server 434.

In an example embodiment, the purchase transaction processing of the purchase reservation request for which the desired purchase condition is satisfied may be performed automatically without requiring a user input or may be performed after receiving user confirmation. After the purchase transaction is processed, the purchase reservation server 434 may transmit information (payment information, and the like) related to the purchase reservation to the first user terminals 410_1 to 410_n that transmitted the corresponding purchase reservation requests.

FIG. 4 shows that the second user terminals 420_1 to 420_n directly communicate with the information processing system 430 to proceed with payment, but example embodiments are not limited thereto. For example, the second user terminals 420_1 to 420_n may provide the payment requests to the payment server 432 via an external server such as an open market, a shopping mall system, and the like.

FIG. 5 is a diagram showing an example in which the purchase reservation request is converted into the standardized notation and then stored according to an example embodiment. Regarding the information on product to be purchased, it is desired to convert it into the standardized notation for efficient information management, because even the same product can be marked in different languages (e.g., English, Korean, and the like) or different names depending on who sells the products. Accordingly, a product DB 510 may be constructed by collecting the notations of the product used by the sellers of the product and storing the notations together with the standardized notation.

In an example embodiment, the reservation information management unit 310 may query the product DB 510 for the information on product to be purchased included in the purchase reservation request, convert it into the standardized notation of the product, and then store the converted notation in the purchase reservation request DB 520. For example, when the same product is marked differently as “Item aa” in shopping mall A and “Item aaa” in shopping mall B, when constructing the product DB 510, “Item aa” and “Item aaa” may be unified and stored as “Item 1”. In this case, when the information on product to be purchased included in the received purchase reservation request is “Item aa” or “Item aaa”, the reservation information management unit 310 may convert it into the standardized notation “Item 1” and store it in the purchase reservation request DB. In some example embodiments, when the information on product to be purchased also includes detailed options (color, capacity, and the like) in addition to the product name, the detailed options may also be standardized in a similar manner and stored in the purchase reservation request DB 520.

This also applies to the notation of the desired purchase condition such that, when the currency (KRW, UDS, JPY, and the like) of the desired purchase price input by the user is different, or when the lowest price ever or a certain percentage discount option is selected, it is desired to convert it into the standardized notation for efficient information management. Accordingly, the reservation information management unit 310 may convert the desired purchase condition included in the purchase reservation request into the standardized notation and store it in the purchase reservation request DB 520. For example, the desired purchase price may be converted into one currency (e.g., KRW) and stored, and the lowest price ever and a certain percentage discount option may be converted into a price and stored.

As shown, the received purchase reservation request after converted into standardized notation may be databased and stored by the reservation information management unit 310. For example, the standardized purchase reservation request may be databased and stored in a memory (e.g., in-memory database) of the information processing system 130, and managed and/or classified. According to another embodiment, a storage device (e.g., cloud server device) may be separately provided externally such that the purchase reservation request may be databased and stored in the external storage device.

FIG. 6 is a diagram showing an example purchase reservation request DB 600 according to an example embodiment. As described above, the purchase reservation request DB 600 may be constructed by converting the purchase reservation request into the standardized notation and storing the same. The purchase reservation request DB 600 may be constructed into any data structure in which user information 610, product name 620, detailed option 630, desired purchase condition 640, payment method information 650, and the like are stored in association with each other.

The user information 610 may be information related to a user who generated the purchase reservation request, such as a user account, user personal information, and the like. The product name 620 and the detailed option 630 may be stored in the standardized notation by querying the product DB. In an example, the detailed option 630 may be a detailed condition that a user may select for the product to be purchased when requesting purchase reservation for the product. For example, the detailed option of “Item 1” may be “black” or “red” as shown in FIG. 6.

The desired purchase condition 640 may include the stored standardized notation of the lowest price ever, discount rate (e.g., 20% discount), desired purchase price, and the like. The payment method information 650 is information for proceeding with the payment of the cost for the product purchase processing that is performed as the desired purchase condition is satisfied, and may include at least one of credit card information, debit card information, phone bill information, financial account information, or simple payment information. For example, as shown in FIG. 6, the payment method information 650 may be simple payment information such as “LINE Pay”.

FIG. 7 is a diagram showing an example in which the payment request is converted into the standardized notation and then stored according to an example embodiment. The payment information management unit 320 may standardize the received payment information and store the same in the payment information DB 730. In an example embodiment, the payment information management unit 320 may query the product DB 710 for the product information included in the payment information, convert it into a standardized notation of the product, and store the converted notation in the payment information DB 730. The product DB 710 may be the same as the product DB 510 shown in FIG. 5. In this case, the reservation information management unit 310 and the payment information management unit 320 may share and use one product DB.

Because the store information for the same store may also be marked in different languages or in different names depending on who generates the store information, it is desired to convert it into the standardized notation for efficient information management. The store DB 720 may be constructed in a manner similar to the product DB. In an example embodiment, the payment information management unit 320 may query the store DB 720 for the store information included in the payment information, convert it into the standardized notation, and store the converted notation in the payment information DB 730. For example, when the same store is marked in different notations such as “Shop aa” and “Shop aaa”, the payment information management unit 320 may query the store DB 720 and convert it into a standardized notation “Shop 1” and store the converted notation in the payment information DB 730.

Finally, the information on the payment amount included in the payment information may also be standardized and stored in the payment information DB 730. For example, the payment amount may be standardized and stored in the same currency (e.g., Korean currency).

As shown, the received payment information after converted into standardized notation may be databased and stored by the payment information management unit 320. For example, the standardized payment information may be databased and stored in a memory (e.g., in-memory database) of the information processing system, and managed and/or classified. According to another example embodiment, a storage device (e.g., cloud server device) may be separately provided externally such that the payment information may be databased and stored in the external storage device.

FIG. 8 is a diagram showing an example payment information DB 800 according to an example embodiment. As described above, the payment information DB 800 may be constructed by converting the payment information into the standardized notation and storing the same. The payment information DB 800 may be constructed into any data structure in which a store name 810, a product name 820, a detailed option 830, a payment amount 840, and the like are stored in association with each other.

The store name 810 may be stored in the standardized notation by querying the store DB. In addition, the product name 820 and the detailed option 830 may be stored in the standardized notation by querying the product DB. In an example, the detailed option 830 may be a detailed condition that the user may select for the paid product when requesting payment. For example, as shown in FIG. 8, the detailed option of “Item 1” may be “black” or “red”, and the detailed option of “Item 2” may be “100 ml” or “50 ml”.

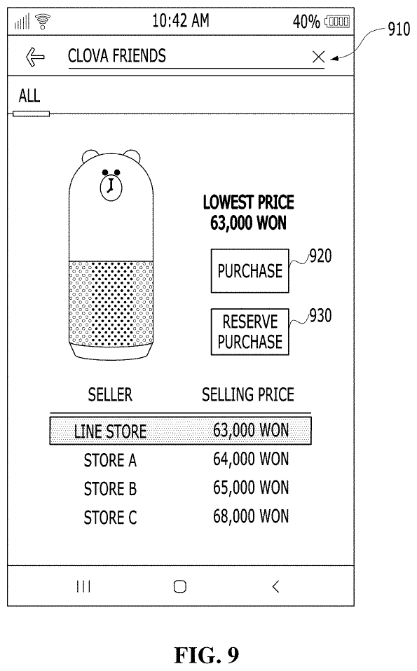

FIG. 9 is a diagram showing an example of a screen for purchasing or reserving future purchase of a specific product according to an example embodiment. According to an example embodiment, the user may input a product name to search in a user search interface 910 in order to purchase the product on a price comparison site or the like. For example, the user may input a search keyword “Clova Friends” in the user search interface 910 to search for a product related to the keyword.

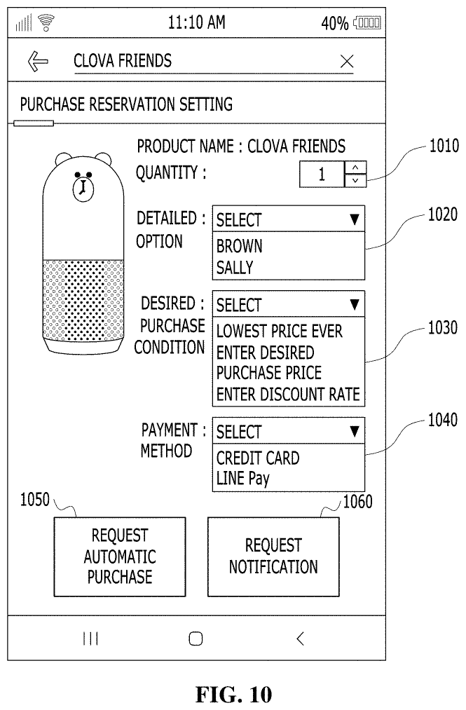

In this case, the search result may be displayed on the screen and provided to the user. For example, the images of the searched product and the stores currently selling the product may be displayed on the screen in order of price. When the user selects one of the stores displayed on the screen and selects a purchase button 920 through a touch input or the like, the user may move to a screen where “Clova Friends” can be immediately purchased and generate a payment request. On the other hand, when the user selects one of the stores displayed on the screen and selects a purchase reservation button 930 through the touch input or the like, the user may move to a screen for reserving a future purchase of “Clova Friends” and generate a purchase reservation request (see FIG. 10).

FIG. 10 is a diagram showing an example of generating a purchase reservation request according to an example embodiment. An interface for generating a purchase reservation request may be displayed on the user terminal. As shown in FIG. 10, the user may input information on a purchase quantity 1010, a detailed option 1020, a desired purchase condition 1030, and a payment method 1040 through the touch input or the like. For example, the user may select “1” as the purchase quantity, “Brown” as the detailed option, “the lowest price ever” as the desired purchase condition, and “LINE Pay” as the payment method.

Then, the user may request a purchase reservation for the product to be purchased by selecting, through the touch input or the like, an automatic purchase request button 1050 for immediately purchasing the product upon the desired purchase condition being satisfied, or selecting a notification request button 1060 such that, when the desired purchase condition is satisfied, information can be received regarding a store where the product can be purchased and the price at which the product can be purchased. When the user selects the purchase request button 1050, a page for requesting user authentication for the payment method may be called. When the user selects the notification request button 1060, the user may input the payment method at a later time when actually purchasing the product, rather than the time of generating the purchase reservation request.

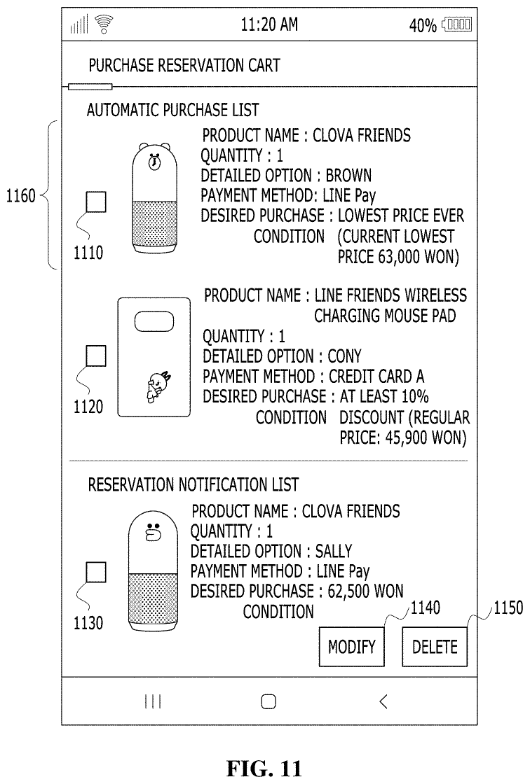

FIG. 11 is a diagram showing an example of querying, by a user, the generated purchase reservation request according to an example embodiment. As shown, the purchase reservation request generated by the user may be sorted and arranged into an automatic purchase list and a reservation notification list, and displayed on the screen. For example, the user may be able to search and manage a list of purchase reservation requests generated by himself or herself, through a purchase reservation cart, which is a user interface for checking and modifying the list of purchase reservation requests.

According to an example embodiment, the user may modify or delete the purchase reservation request included in the purchase reservation shopping cart by using the user interface 1110, 1120, 1130, 1140, and 1150 for modifying or deleting the purchase reservation request. For example, the user may modify or delete the corresponding purchase reservation request list by selecting a check box 1110, 1120, 1130 for the purchase reservation request to be modified or deleted, and selecting a modification button 1140 or a delete button 1150 by touch input or the like. When selecting the modification button 1140, the user is able to modify the purchase quantity, detailed options, payment method, desired purchase condition, and the like, and also modify the automatic purchase into reservation notification.

According to an example embodiment, the user may select one of the purchase reservation requests displayed on the list of purchase reservation requests to receive the information on product to be purchased included in the purchase reservation request. In an example, the information on product to be purchased may include the current lowest price of the product to be purchased, the payment information on product to be purchased, review information, detailed product images, and related event information. For example, by touching an area 1160 displayed in the purchase reservation shopping cart that displays the product name “Clova Friends” and the purchase reservation request for the detailed option “Brown”, the user may search the current lowest price for the corresponding “Clova Friends” and “Brown”, the payment information of other users (including paid stores, payment amounts, and the like), review information, detailed images, related event information, and the like.

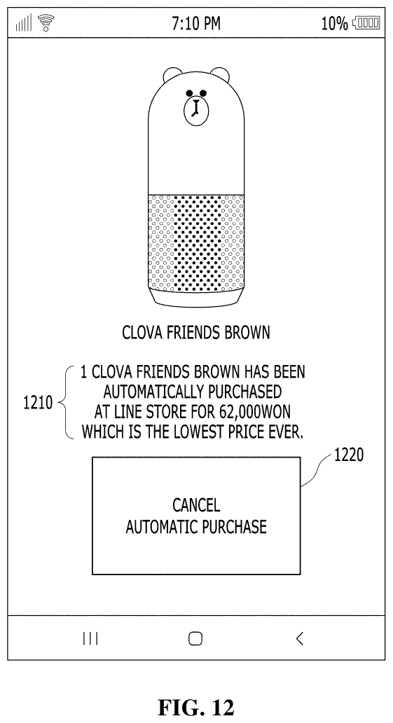

FIG. 12 is a diagram showing an example of providing information related to a purchase transaction to the user after the product to be purchased is automatically purchased, according to an example embodiment. As shown, when the desired transaction condition of the purchase reservation request generated by the user is satisfied and the product to be purchased is automatically purchased, the user may be provided with information related to the purchase transaction completed through the user terminal. In this case, a user interface 1220 for canceling the automatic purchase may be displayed on the user terminal along with the information related to the processed purchase transaction.

As shown in FIG. 12, the image and product name of the automatically purchased product “Clova Friends Brown” are displayed on the screen of the user terminal, and a message 1210 of “1 Clova Friends Brown was automatically purchased from LINE STORE for 62,000 won, the lowest price ever” may also be displayed under the image. Further, an automatic purchase cancellation button 1220 for canceling the automatically purchased transaction may also be output on the screen of the user terminal. The user may cancel the corresponding automatic purchase by selecting the automatic purchase cancellation button 1220. In some example embodiments, the user may only be provided with the information related to the automatic purchase without the automatic purchase cancel button 1220. In some example embodiments, the user may be provided with a link such as a URL leading to a screen providing information related to the automatic purchase. The information related to the purchase transaction may be provided through an application installed in the user terminal as well as a pop-up screen. As an example, when the desired transaction condition of the purchase reservation request generated by the user is satisfied and the product to be purchased is automatically purchased, the information related to the completed purchase transaction may be provided through an instant messaging application installed on the user terminal of the user. In this case, the information related to the completed purchase transaction may be delivered through a messenger in the form of an action message including a user interface 1220 for canceling the automatic purchase. The information related to the purchase transaction may be provided in a form such as a short message service (SMS), a chat window through a dedicated application, an audio form output, and the like, but not limited thereto.

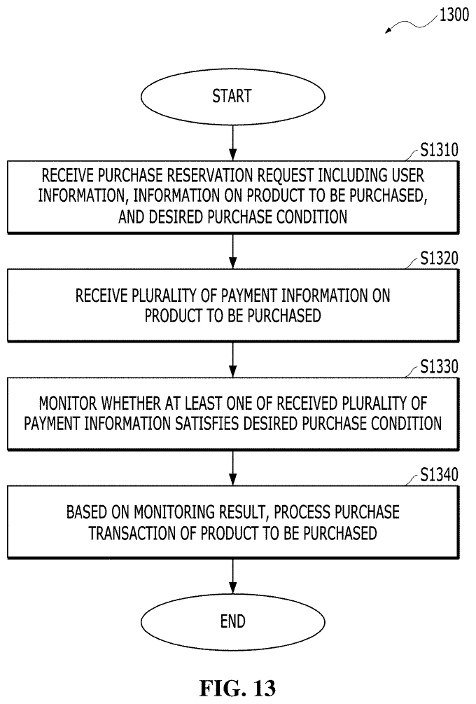

FIG. 13 is a flowchart showing a method 1300 for reserving future purchases of goods according to an example embodiment. The method 1300 for reserving future purchases of goods may be performed by the information processing systems 130 and 430 of FIGS. 1, 2 and 4. As shown, the method 1300 for reserving future purchases of goods may be initiated at S1310, by receiving a purchase reservation request including user information, information on product to be purchased, and a desired purchase condition from a user terminal. In an example, the information on product to be purchased may include at least one of a product name or a detailed option. Further, the desired purchase condition may include at least one of a lowest price ever, a discount rate, or a desired purchase price. In an example embodiment, at least one of the information on product to be purchased or the desired purchase condition included in the received purchase reservation request may be converted into the standardized notation and stored.

Then, at S1320, a plurality of payment information for the product to be purchased may be received. Each of the plurality of payment information may include at least one of user information, product information, store information, or information on payment amount. In an example embodiment, at least one of the product information, the store information, or the information on payment amount included in the received payment information may be converted into the standardized notation and stored.

Next, at S1330, monitoring whether at least one of the received plurality of payment information satisfies the desired purchase condition may be performed. According to an example embodiment, the monitoring may include monitoring whether or not there is payment information, from among the received plurality of payment information, satisfying the desired purchase condition of the purchase reservation request. For example, this may include checking whether or not there is payment information satisfying the desired purchase condition by comparing the product information and the information on the payment amount included in the plurality of payment information with the product to be purchased and the desired purchase condition included in the purchase reservation request.

Finally, at S1340, a purchase transaction of the product to be purchased may be processed using the payment method information received from the user terminal, based on the monitoring result. In an example, the payment method information may include at least one of credit card information, debit card information, phone bill information, financial account information, or simple payment information. According to an example embodiment, the purchase transaction of the product to be purchased may be automatically performed without requiring a user input by using the store information included in the payment information satisfying the desired purchase condition, the user information and the payment method information included in the purchase reservation request. In some example embodiments, when at least one of the store information or the information on the payment amount included in the payment information satisfying the desired purchase condition is transmitted to the user terminal, and when the purchase approval for the product to be purchased is received from the user terminal, the purchase transaction of the product to be purchased may be performed using the store information, the user information, and the payment method information.

In an example embodiment, the purchase transaction of the product to be purchased may be processed when it is determined that a desired (or alternatively, predetermined) quantity or more of the product to be purchased has been purchased at the store that satisfies the desired purchase condition. In some example embodiments, the purchase transaction of the product to be purchased may be processed when it is determined that, for the product to be purchased, the purchase satisfying the desired purchase condition has been made for a desired (or alternatively, predetermined) period of time or longer at a specific store. In addition, when there are multiple purchase reservation requests that satisfy the desired purchase condition (e.g., when there are purchase reservation requests competing with each other), priority may be assigned based on a time when the requests are received and/or the grades of the users who generated the requests, and the purchase transactions may be sequentially processed based on the assigned priority.

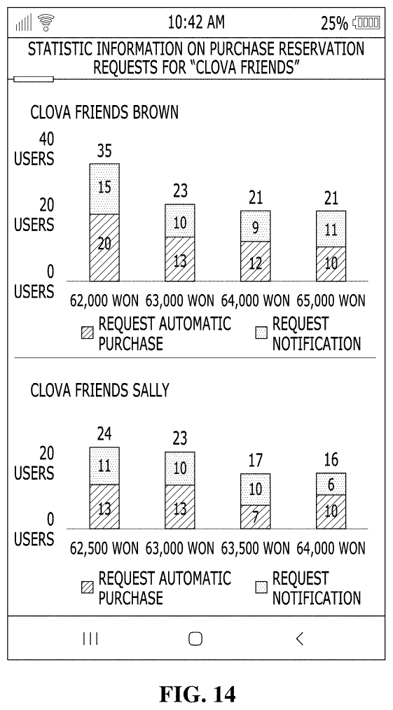

FIG. 14 is a diagram showing an example of displaying statistical information on the purchase reservation request on the screen of the user terminal, according to an example embodiment. The reservation information management unit may generate statistical information based on a plurality of purchase reservation requests received from a plurality of user terminals. In an example, the received plurality of purchase reservation requests may be stored in a memory after at least one of the information on product to be purchased or the desired purchase condition is converted into the standardized notation.

According to an example embodiment, the statistics on the desired purchase condition may be generated for each product to be purchased and provided to the user terminal associated with a seller account through a communication module. As shown, the reservation information management unit 310 may generate statistical information on the desired purchase condition for each detailed option (e.g., Brown, Sally) of “Clova Friends”, and provide the generated statistical information to a seller account that sells or registers “Clova Friends” as a product of interest. In this case, the desired purchase condition may be converted into the standardized notation (e.g., KRW) and displayed.

According to an example embodiment, the statistical information received from the reservation information management unit may be displayed on the screen of the user terminal in the form of a graph. As shown, the statistical information on the purchase reservation request for “Clova Friends Brown” and “Clova Friends Sally” may be displayed in a graph form on the screen. In this case, in the graph, the forms of the purchase reservation request, that is, the number of automatic purchase requests and notification requests may be separately displayed.

The statistical information may be output not only in the graph form, but also in various forms, such as a text form, and provided to sellers. Because the statistical information on the purchase reservation request is provided, the seller is able to check the demand and demand price of each product, and use this strategically. That is, based on the statistical information, the seller may predict with high accuracy how the sales volume will increase according to the degree of decreasing the selling price of the product he or she is selling. For example, based on statistical information, a seller who sells “Clova Friends Brown” product may be able to confirm that 10 products will be automatically purchased and 11 users will be notified of the desired purchase condition being satisfied, when the selling price is decreased to “65,000 won”.

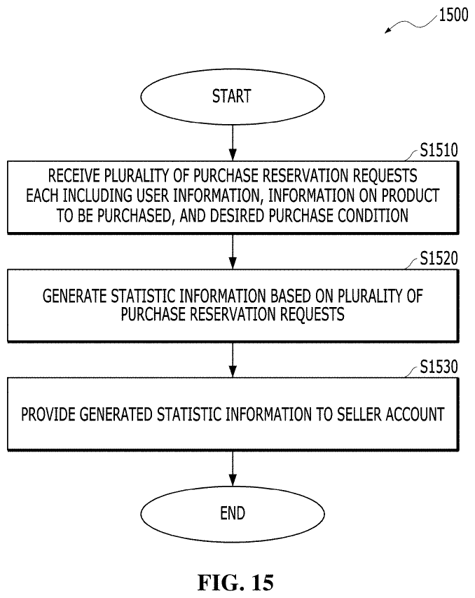

FIG. 15 is a flowchart showing a method 1500 for predicting consumer demand according to an example embodiment. The method may be performed by the information processing systems 130 and 430 of FIGS. 1, 2 and 4. As shown, the method 1500 for predicting consumer demand may be initiated at S1510, by receiving a plurality of purchase reservation requests each including user information, information on product to be purchased, and a desired purchase condition. According to an example embodiment, at least one of the received information on product to be purchased or desired purchase condition may be converted into the standardized notation and stored.

Then, at S1520, generating the statistical information based on a plurality of purchase reservation requests may be performed. According to an example embodiment, the statistics on the desired purchase condition may be generated for each product to be purchased. In this case, the desired purchase condition may be converted into the standardized notation (e.g., KRW) and displayed.

Finally, the statistical information generated at S1530 may be provided to the seller account. According to an example embodiment, a product for sale at the seller account may be confirmed, and then the statistics of the desired purchase condition for the product for sale at the seller account (e.g., a subset of the statistics of the desired purchase condition corresponding to the product for sale at the seller account) may be provided to the seller account. In some example embodiments, the product selected as the product of interest by the seller account may be confirmed, and then the statistics of the desired purchase condition for the product of interest may be provided to the seller account.

The seller may modify the selling price of the product he or she sells based on the statistical information provided from the information processing system (e.g., consumer demand forecast system) to make a purchase transaction for the stored purchase reservation request. In an example embodiment, the consumer demand forecast system may receive from the seller account a modified selling price for the product for sale. In this case, the consumer prediction demand system may determine at least one purchase reservation request that satisfies the desired purchase condition based on the received selling price, and process the purchase transaction for the at least one purchase reservation request that satisfies the desired purchase condition.

The method for reserving future purchases of goods and method for predicting consumer demand described above may be implemented as computer readable codes on a computer readable recording medium. The computer readable recording medium includes all kinds of recording devices in which data readable by a computer system is stored. Examples of computer readable recording medium include ROM, RAM, CD-ROM, magnetic tape, floppy disks, and optical data storage devices, and the like. In addition, the computer readable recording medium may be distributed over network coupled computer systems so that the computer readable code is stored and executed in a distributed manner. Further, programmers in the technical field pertinent to the present disclosure will be easily able to envision functional programs, codes and code segments to implement the example embodiments.

The methods, operations, or techniques of this disclosure may be implemented by various means. For example, these techniques may be implemented in hardware, firmware, software, or a combination thereof. Those skilled in the art will further appreciate that the various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or a combination of hardware and software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the disclosure, computer, or a combination thereof.

Accordingly, various example logic blocks, modules, and circuits described in connection with the disclosure may be implemented or performed with general purpose processors, DSPs, ASICs, FPGAs or other programmable logic devices, discrete gate or transistor logic, discrete hardware components, or any combination of those designed to perform the functions described herein. A general purpose processor may be a microprocessor, but in the alternative, the processor may be any conventional processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The commands may be executable by one or more processors, and may cause the processor(s) to perform certain aspects of the functions described in the present disclosure.

When implemented in software, the techniques may be stored on a computer readable medium as one or more command or codes, or may be transmitted through a computer readable medium. The computer readable medium includes both the computer storage medium and the communication medium including any medium that facilitate the transfer of a computer program from one place to another. The storage media may also be any available media that may be accessed by a computer. By way of non-limiting example, such a computer readable medium may include RAM, ROM, EEPROM, CD-ROM or other optical disk storage, magnetic disk storage or other magnetic storage devices, or any other media that can be used to transfer or store desired program code in the form of instructions or data structures and can be accessed by a computer. Further, any connection is properly referred to as a computer readable medium.

For example, when the software is transmitted from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer readable media.

The software module may reside in, RAM memory, flash memory, ROM memory, EPROM memory, EEPROM memory, registers, hard disk, removable disk, CD-ROM, or any other form of storage medium known. An example storage medium may be connected to the processor, such that the processor may read or write information from or to the storage medium. In some example embodiments, the storage medium may be integrated into the processor. The processor and the storage medium may exist in the ASIC. The ASIC may exist in the user terminal. In some example embodiments, the processor and storage medium may exist as separate components in the user terminal.

According to the example embodiments, a computing system (e.g., at least one processor) may enable a user to purchase the product at a desired price by actively utilizing the payment information of other users, instead of continuously monitor a product, and thus consumes less computing and/or network resources. For example, a computing system (e.g., at least one processor) may not have to continuously monitor product trading trends at the expense of computing and/or network resources to find the lowest price product that is actually traded (e.g., is not a falsely sold). In some example embodiments, a computing system (e.g., at least one processor) may enable the sellers to easily and quickly check the demand and demand price of product based on statistical information on purchase reservation requests registered by users (e.g., buyers), without engaging in substantial post data processing, which demands significant computing and/or network resources.

Although the example embodiments described above have been described as utilizing aspects of the currently disclosed subject matter in one or more standalone computer systems, the present disclosure is not limited thereto, and may be implemented in conjunction with any computing environment, such as a network or distributed computing environment. Furthermore, aspects of the subject matter in this disclosure may be implemented in multiple processing chips or devices, and storage may be similarly influenced across a plurality of devices. Such devices may include PCs, network servers, and portable devices.

Although the present disclosure has been described in connection with some example embodiments herein, various modifications and changes can be made without departing from the scope of the present disclosure, which can be understood by those skilled in the art to which the present disclosure pertains. In addition, such modifications and changes should be considered within the scope of the claims appended herein.

What is claimed is:

1. A method for reserving future purchases of goods performed by one or more processors, comprising:
receiving a purchase reservation request from a user terminal, the purchase reservation request including user information, information on a product to be purchased, and a desired purchase condition;
receiving a plurality of payment information on the product to be purchased;
monitoring whether at least one of the received plurality of payment information satisfies the desired purchase condition; and
processing a purchase transaction of the product to be purchased using payment method information received from the user terminal, based on a result of the monitoring.

2. The method according to claim 1, wherein
the purchase reservation request further includes the payment method information, and
the processing includes,
automatically performing, without a user input, the purchase transaction of the product to be purchased using store information included in specific payment information that satisfies the desired purchase condition among the received plurality of payment information, and using the user information and the payment method information included in the purchase reservation request, and
transmitting information related to the purchase transaction to the user terminal.

3. The method according to claim 1, wherein the processing includes:
transmitting at least one of store information or information on payment amount included in specific payment information, from among the received plurality of payment information that satisfies the desired purchase condition, to the user terminal;
receiving a purchase approval for the product to be purchased from the user terminal; and
performing the purchase transaction of the product to be purchased using the store information, the user information, and the payment method information.

4. The method according to claim 1, wherein the receiving the purchase reservation request includes converting at least one of the information on the product to be purchased or the desired purchase condition into a standardized notation.

5. The method according to claim 1, wherein
each of the received plurality of payment information includes at least one of product information, store information, or information on payment amount, and
the receiving the plurality of payment information on the product to be purchased includes converting at least one of the product information, the store information, or the information on payment amount included in each of the received plurality of payment information into a standardized notation.

6. The method according to claim 1, wherein the processing includes processing the purchase transaction of the product to be purchased using the information on a store, the user information, and the payment method information, in response to the result of the monitoring indicating that a desired quantity of the product to be purchased has been purchased at the store satisfying the desired purchase condition.

7. The method according to claim 1, wherein the processing includes processing the purchase transaction of the product to be purchased using the information on a specific store, the user information, and the payment method information, in response to the result of the monitoring indicating that purchases satisfying the desired purchase condition have been made for a desired period of time at the specific store.

8. The method according to claim 1, wherein the processing includes:
assigning priority based on reception time of the purchase reservation request and another purchase reservation request, in response to receiving the another purchase reservation request that competes with the purchase reservation request; and
processing the purchase transaction for each of the purchase reservation request and the another purchase reservation request based on the assigned priority.

9. The method according to claim 1, wherein the processing includes:
assigning priority based on grades of users who have generated the purchase reservation request and another purchase reservation request, in response to receiving the another purchase reservation request that competes with the purchase reservation request; and
processing the purchase transaction for each of the purchase reservation request and the another purchase reservation request based on the assigned priority.

10. The method according to claim 1, wherein the information on the product to be purchased includes at least one of a product name, a product model name, a product image, or a detailed option.

11. The method according to claim 1, wherein the monitoring includes determining a specific payment information, from among the plurality of payment information, which is more advantageous than the desired purchase condition as the payment information that satisfies the desired purchase condition.

12. The method according to claim 1, wherein the processing includes:
determining whether the product to be purchased that satisfies the desired purchase condition can be purchased under the desired purchase condition using store information and the payment method information received from the user terminal; and
transmitting a message requesting an input of another payment method information to the user terminal in response to a result of the determining indicating that the another payment method information different from the payment method information received from the user terminal is desired to purchase the product to be purchased under the desired purchase condition.

13. The method according to claim 1, further comprising:
receiving a plurality of purchase reservation requests from a plurality of terminals, each of the plurality of purchase reservation requests including respective user information, respective information on each product to be purchased, and a respective desired purchase condition;
generating statistical information based on the plurality of purchase reservation requests; and
transmitting the generated statistical information to a seller terminal associated with a seller account.

14. The method according to claim 13, wherein the receiving the plurality of purchase reservation requests includes converting at least one of the respective information on each product to be purchased or the respective desired purchase condition included in each of the received plurality of purchase reservation requests into a standardized notation.

15. The method according to claim 13, wherein
the generating includes generating statistics on the respective desired purchase condition for each product to be purchased included in each of the received plurality of purchase reservation requests, and
the transmitting includes,
identifying a specific product sold by the seller account, and
providing a subset of the statistics on the desired purchase condition for the specific product sold by the seller account to the seller terminal associated with the seller account.

16. The method according to claim 13, further comprising:
receiving a modified selling price for a specific product for sale from the seller account;
determining at least one purchase reservation request, from among the plurality of purchase reservation requests, that includes the respective desired purchase condition satisfied by the modified selling price; and
processing the purchase transaction for the at least one purchase reservation request.

17. A non-transitory computer-readable recording medium storing instructions for execution by the one or more processors that, when executed by the one or more processors, cause the one or more processors to perform the method according to claim 1.

18. A system for reserving future purchases of goods, comprising:
a memory; and
at least one processor connected to the memory and configured to execute computer-readable commands stored in the memory,
wherein the at least one processor is configured to,
receive a purchase reservation request including user information, information on a product to be purchased, and a desired purchase condition, and store the purchase reservation request in the memory,
receive a plurality of payment information on the product to be purchased and store the plurality of payment information in the memory,
monitor whether at least one of the received plurality of payment information satisfies the desired purchase condition, and
process a purchase transaction of the product to be purchased using received payment method information, based on a monitoring result.
